(19) United States
(12) Patent Application Publication
(10) Pub. No.: US 2008/0245115 A1
(43) Pub. Date: Oct. 9, 2008

(54) Steam Generator and Washing Machine Having the Same

(76) Inventor: Ki Chul Cho, Gyeongsangnam-do (KR)

Correspondence Address: MCKENNA LONG & ALDRIDGE LLP, 1900 K STREET, NW, WASHINGTON, DC, 20006, US

(21) Appl. No.: 11/661,592

(22) PCT Filed: May 22, 2006
(86) PCT No.: PCT/KR06/01915

§ 371 Date: Jan. 18, 2008

(30) Foreign Application Priority Data
May 23, 2005 (KR) 10-2005-0043094
May 23, 2005 (KR) 20-2005-0014507

(51) Int. Cl. D06F 37/02; B08B 3/00

(52) U.S. Cl. 68/5 R; 68/5 C

(57) ABSTRACT

A steam generator (210) for preventing a case (211) of the steam generator (210) from bursting when water supplied into the case is frozen and a drum type washing machine having the same are disclosed. The washing machine includes a tub (120) mounted in a cabinet (110), which constitutes the external appearance of the washing machine, for storing wash water, a drum (130) rotatably mounted in the tub (120), and a steam generator (210) mounted in the cabinet (110) for supplying steam into the drum (130). The steam generator (210), for preventing the case (211) from bursting when water supplied into the case is frozen.

### TECHNICAL FIELD

The present invention relates to a drum type washing machine, and more particularly, to a drum type washing machine having a steam generator for preventing a case of the steam generator from bursting when water supplied into the case is frozen.

### BACKGROUND ART

Generally, washing machines are classified into a pulsator type washing machine, which performs a washing operation using water stream generated by the rotation of a plate-shaped pulsator, and a drum type washing machine, which performs a washing operation using falling of wash water and laundry and a friction force between the wash water and the laundry generated in a horizontally disposed drum by the rotation of the drum.

The drum type washing machine has been increasingly used since the drum type washing machine has advantages superior to the pulsator type washing machine in that the amount of wash water and detergent used during the washing operation is small, damage to the laundry is minimized, and the laundry is minimally tangled.

The structure of a conventional drum type washing machine will be described hereinafter with reference to FIG. 1.

As shown in FIG. 1, the conventional drum type washing machine includes a cabinet 10 constituting the external appearance of the drum type washing machine, a cylindrical tub 20 horizontally supported in the cabinet for storing wash water, a drum 30 rotatably mounted in the tub 20, the drum 30 being provided with through-holes (not shown), through which wash water and steam are introduced into the drum 30, a driving motor 40 for driving the drum 30, and at least one steam generator 50 for supplying steam into the drum 30.

At the front part of the cabinet 10 is formed a laundry opening 13, which communicates with the interior of the drum 30 such that laundry can be put into or removed from the drum 30 through the laundry opening 13.

A door 11 is hingedly mounted to the cabinet 10 adjacent to the laundry opening 13 for opening and closing the laundry opening 13.

Along the inner circumference of the laundry opening 13 is mounted a gasket (not shown) for preventing hot air from leaking through the connection between the door 11 and the tub 20.

At one side of the drum type washing machine is provided a water supply valve 15, which is connected to an external water pipe (not shown) for supplying wash water into the tub 20 or supplying water into the steam generator 50.

The steam generator 50 is connected with the water supply valve 15 such that the water supplied from the water supply valve 15 can be introduced into the steam generator 50. The steam generator 50 heats the water supplied from the water supply valve 15 to generate steam, and supplies the generated steam into the drum 30.

The steam generator 50 includes a case 51 constituting the external appearance of the steam generator, a water level detecting sensor 60 for detecting the water level of water supplied into the case 41, a heater 55 for heating the water supplied into the case 41, and a temperature detecting sensor 57 for detecting the temperature of the heated water.

At one side of the steam generator 50 is mounted a steam supply pipe 53, which is a passage for guiding and injecting the steam generated by the steam generator 50 into the drum 30.

However, the conventional drum type washing machine with the above-stated construction has the following problem.

A general washing operation may be carried out or a washing operation may be finished during the malfunction of the water level detecting sensor 60 mounted in the steam generator 50 or the malfunction of the heater 55 mounted in the steam generator 50 in the state that water is supplied into the case 51 of the steam generator 50 to the maximum water level.

For example, the case 51 may burst when the water supplied into the case 51 is frozen, and therefore, the volume of the water is increased due to low surrounding temperature as in the winter season.

### DISCLOSURE OF INVENTION

### Technical Problem

An object of the present invention devised to solve the problem lies on a steam generator for preventing a case of the steam generator from bursting when water supplied into the case is frozen and a drum type washing machine having the same.

### Technical Solution

The object of the present invention can be achieved by providing a steam generator for drum type washing machines, comprising: a case Instituting the external appearance of the steam generator; and a burst preventing unit provided at the case for preventing the case from bursting when water supplied into the case is frozen.

Preferably, the burst preventing unit is a spare space part formed in the case.

Preferably, the spare space part is a space provided such that 10% more water, than when water is supplied to the maximum water level, can be supplied into the case.

Preferably, the spare space part is provided by forming one side part of the upper surface of the case outward to expand the inner space of the case.

Preferably, the spare space part is provided with an outlet port, through which steam is discharged.

Preferably, the burst preventing unit is a convex part which protrudes to secure the inner space of the case.

Preferably, the convex part is provided by forming the upper surface of the case outward to expand the inner space of the case.

In another aspect of the present invention, provided herein is a washing machine including a tub mounted in a cabinet, which constitutes the external appearance of the washing machine, for storing wash water, a drum rotatably mounted in the tub, and a steam generator mounted in the cabinet for supplying steam into the drum, wherein the steam generator comprises a burst preventing unit provided at a case, which constitutes the external appearance of the steam generator, for preventing the case from bursting when water supplied into the case is frozen.

Preferably, the burst preventing unit is a spare space part formed in the case.

Preferably, the spare space part is a space provided such that 10% more water, than when water is supplied to the maximum water level, can be supplied into the case.

Preferably, the spare space part is provided by forming one side part of the upper surface of the case outward to expand the inner space of the case.

Preferably, the spare space part is provided with an outlet port, through which steam is discharged.

Preferably, the burst preventing unit is a convex part which protrudes to secure the inner space of the case.

Preferably, the convex part is provided by forming the upper surface of the case outward to expand the inner space of the case.

### ADVANTAGEOUS EFFECTS

The steam generator for drum type washing machines with the above-stated construction has the following effects.

According to the present invention, the case is prevented from bursting by means of the bursting preventing unit provided at the upper part of the case even when the water supplied into the case is frozen, and therefore, the volume of the water is increased.

### BRIEF DESCRIPTION OF THE DRAWINGS

The accompanying drawings, which are included to provide a further understanding of the invention, illustrate embodiments of the invention and together with the description serve to explain the principle of the invention.

In the drawings:

FIG. 1 is a perspective view schematically illustrating the structure of a conventional drum type washing machine.

FIG. 2 is a longitudinal sectional view illustrating the structure of a drum type washing machine according to the present invention.

FIG. 3 is a perspective view illustrating the external structure of a steam generator according to a first embodiment of the present invention.

FIG. 4 is a perspective view illustrating the internal structure of the steam generator according to the first embodiment of the present invention.

FIG. 5 is a perspective view illustrating the structure of a steam generator according to a second embodiment of the present invention.

FIG. 6 is a schematic view illustrating the internal structure of the steam generator according to the second embodiment of the present invention.

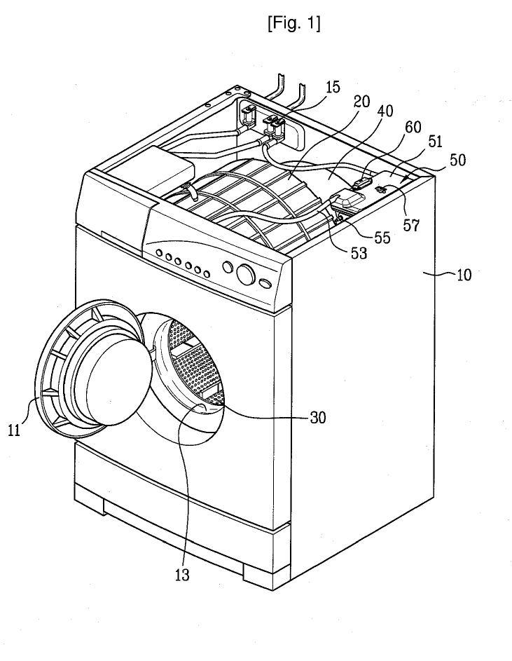

### BEST MODE FOR CARRYING OUT THE INVENTION

Reference will now be made in detail to the preferred embodiments of the present invention, examples of which are illustrated in the accompanying drawings.

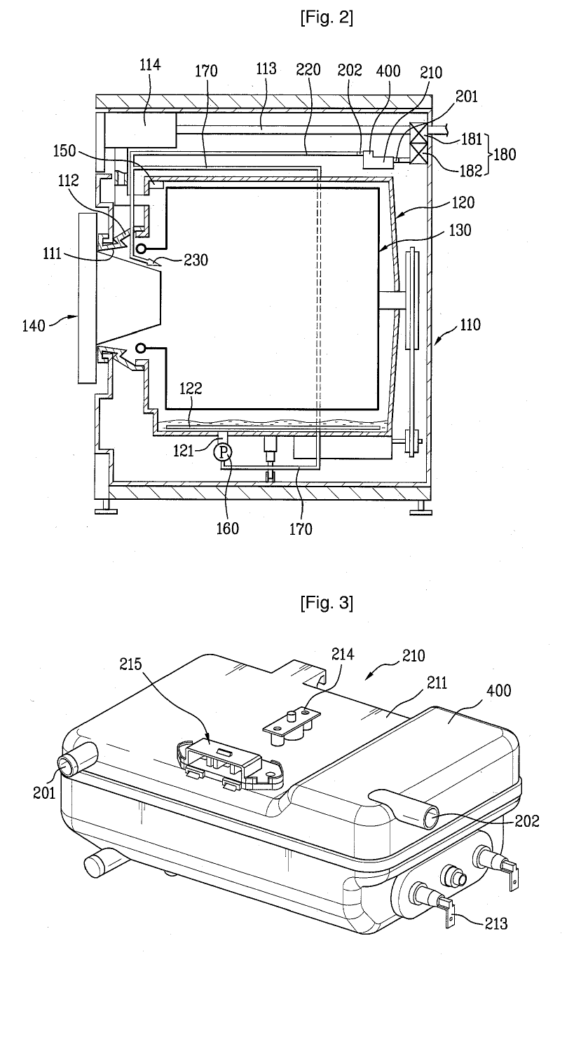

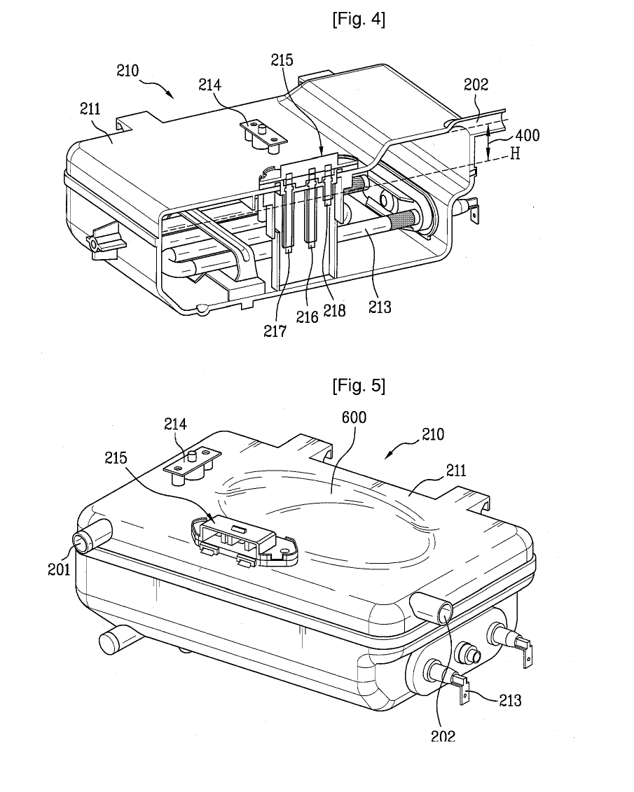

FIG. 2 is a longitudinal sectional view illustrating the structure of a drum type washing machine according to the present invention, FIG. 3 is a perspective view illustrating the external structure of a steam generator according to a first embodiment of the present invention, and FIG. 4 is a perspective view illustrating the internal structure of the steam generator according to the first embodiment of the present invention.

As shown in FIG. 2, the washing machine according to the present invention includes a machine case 110, a tub 120, a drum 130, a steam supply unit, a temperature sensor 150, a circulating pump 160, a circulating channel 170, and a water level sensor (not shown) for detecting the water level of the wash water in the tub 120. In this embodiment, the washing machine is a drum type washing machine.

The machine case 110 constitutes the external appearance of the drum type washing machine. At the front part of the machine case 110 is formed a laundry opening 111.

A door 140 is mounted to the machine case 110 adjacent to the laundry opening 111 for opening and closing the laundry opening 111. At the inner circumference of the laundry opening 111 is mounted a gasket 112, which accomplishes sealing between the door 140 and the laundry opening 111.

Also, the machine case 110 is provided with a wash water supply pipe 113 for supplying wash water into the tub 120. On the pipe line of the wash water supply pipe 113 is mounted a detergent box 114.

The tub 120 is mounted in the machine case 110 in a supported state.

To the bottom of the tub 120 is connected a drainage channel 121 for draining wash water.

At the lower end of the tub 120 is mounted a wash water heater 122 for heating wash water supplied into the tub 120.

The drum 130 is rotatably mounted in the tub 120, and is disposed such that the open side of the drum 130 is directed to the laundry opening 111 of the machine case 110.

At the circumference of the drum 130 are formed a plurality of through-holes (not shown), through which wash water and steam supplied into the tub 120 are introduced into the drum 130.

The steam supply unit is constructed to supply a predetermined amount of steam into the tub 120 and/or the drum 130. In this embodiment, at least one steam supply unit is provided.

The circulating pump 160 is mounted on the drainage channel 121, which is connected to the tub 120, and is operated to pump the wash water supplied into the tub 120 such that the wash water can be circulated.

The circulating channel 170 is a pipe line which is connected to the circulating pump 160 for guiding the circulating movement of the wash water pumped by the circulating pump 160.

Preferably, the end of the circulating channel 170, i.e., the wash water discharging side, extends through the gasket 112 such that the end of the circulating channel 170 is directed to the inside wall of the drum 130. In this embodiment, the end of the circulating channel 170 is connected to the steam supply pipe 220 as shown in the accompanied drawings. Alternatively, the end of the circulating channel 170 may be connected to the inside of the drum 130 without being connected to the steam supply pipe 220.

The temperature sensor 150 is mounted at a predetermined position in the tub 120 for detecting the interior temperature of the tub 120. The temperature detected by the temperature sensor 150 may be used to operate the steam supply unit and to cDntrol the wash water heater 122.

Meanwhile, unexplained reference numeral 180 indicates a water supply valve assembly 180 for selectively supplying wash water introduced from the outside to the detergent box 114 or the steam supply unit, reference numeral 181 indicates a wash water supply valve for controlling the supply of wash water into the tub 120 through the detergent box 114, and reference numeral 182 indicates a water-for-steam supply valve for controlling the supply of wash water into the steam supply unit.

For example, the steam supply unit is constructed to evaporate water, using high-temperature hot air, into steam and to supply the steam into the tub 120 and/or the drum 130. The steam supply unit includes a steam generator (SG) 210 for generating high-temperature hot air to evaporate water into steam, a steam supply pipe 220, through which steam generated from the water evaporation by the steam generator 210 flows, and an injection nozzle 230 for injecting the steam flowing through the steam supply pipe 220 into the tub 120 and/or drum 130.

The injection nozzle 230 is constructed in the shape of a nozzle such that the steam can be smoothly injected through the nozzle. Preferably, the end of the injection nozzle 230, through which the steam is discharged extends through the gasket 112 such that the end of the injection nozzle 230 is directed to the interior of the drum 130.

According to the present invention, the stem generator 210 includes a case 211, a steam heater 213, a steam side temperature sensor 214, a water level sensor 215, and a bursting preventing unit.

The case 211 may be constructed in the shape of a rectangular box, which Institutes the external appearance of the steam generator 210 and forms a steam generation space.

The case 211 is provided with an inlet port 201, through water is supplied into the case 211, and an outlet port 202, through which steam generated in the case is discharged.

The steam heater 213 is mounted in the case 211 for evaporating moisture stored in the case 211 through the heat generation of the steam heater 213.

The steam heater 213 may be constructed using a sheath heater. Although not shown in the drawings, a fuse is mounted in the steam heater 213 for interrupting the supply of power when the steam generator 210 is overheated to protect the steam generator 210.

The steam side temperature sensor 214 is electrically connected to a controller (not shown) of the washing machine. The steam side temperature sensor 214 serves to detect the interior temperature of the case 211 when the heat is generated from the steam heater 213.

The water level sensor 215 includes three electrodes, i.e., a common electrode 216, a long electrode 217, and a short electrode 218. The water level sensor 215 serves to detect the water level of the water in the case 211.

The water level sensor 215 is electrically connected to the controller (not shown) of the washing machine, which controls all operations of the components of the washing machine, including the water supply valve assembly 180 and the steam heater 213.

Preferably, the common electrode 216 and the long electrode 217 are formed such that the terminals of the common electrode 216 and the long electrode 217 are exposed approximately at the height set as the minimum water level of the water necessary to generate steam. Also preferably, the short electrode 218 is shorter than the common electrode 216 and the long electrode 217, and is formed such that the terminal of the short electrode 218 is exposed approximately at the height set as the maximum water level of the water necessary to generate steam.

Preferably, the height at which the terminals of the long electrode 217 and the common electrode 216 are exposed is a height at which the steam heater 213 is fully submerged in the water.

The burst preventing unit is provided at the case 211 for preventing the case 211 from bursting when water supplied into the case 211 is frozen.

According to a first embodiment of the present invention, the burst preventing unit is a spare space part 400 formed to prevent the case 211 from bursting when the water supplied into the case to the maximum water level H is frozen, and therefore, the volume of the water is increased.

The spare space part 400 is a space provided such that 10% more water, than when water is supplied to the maximum water level, can be supplied into the case 211.

The spare space part 400 is provided by forming one side part of the upper surface of the case 211 upward to expand the inner space of the case 211.

The water supplied into the case 211 of the steam generator 210 to the maximum water level may be frozen due to low external temperature.

At this time, the water supplied into the case 211 to the maximum water level is frozen, and therefore, the volume of the water is increased. According to the present invention, however, the increased portion of the frozen water is filled in the spare space part 400 provided in the case 211, and therefore, the case 211 is prevented from bursting.

Meanwhile, the above-described outlet port 202 may be disposed at one side of the spare space part 400.

The drum type washing machine having the steam generator with the above-stated Instruction is operated as follows.

First, when electric power is supplied to the drum type washing machine, the controller (not shown) of the drum type washing machine controls the water supply valve 181 of the water supply valve assembly 180 to supply wash water into the tub 120 to a predetermined water level, controls the circulating pump 160 to circulate the wash water in the tub 120 to the upper part of the drum 130 along the outside of the tub 120, and controls the drum 130 to be rotated such that a laundry wetting process is carried out.

At this time, the controller controls the water-for-steam water supply valve 182 of the water supply valve assembly 180 to supply a predetermined amount of water into the case 211 of the steam generator 210.

After the water is supplied into the case 211, the water level of the supplied water is detected by the steam side water level sensor 215, as previously described.

Meanwhile, the water supplied into the case 211 is heated by the steam heater 213 such that the water is changed into steam.

Subsequently, the steam is discharged into the drum 30, in which laundry is received, through the outlet port 202 of the case 211, and then a laundry wetting process and a laundry soaking process are carried out.

The steam generator 210 repeatedly performs the above-described procedure, whereby the steam is supplied into the drum 130.

While the laundry is wetted by the resupply of water into the tub 120, the rotation of the drum 130, and the operation of the circulating pump 160, high-temperature steam is injected into the drum 130 by the steam generator 210 according to the present invention, whereby the interior of the drum 130 reaches a predetermined temperature which is most effective in the washing efficiency of the washing machine.

The laundry wetting process and the steam supply process through the steam generator 210 are carried out until the temperature detected by the temperature sensor 150 reaches a target temperature.

When the temperature detected by the temperature sensor 150 reaches a target temperature, the supply of steam through the steam generator 210 is interrupted, and the wash water supply valve 181 is controlled to supply water into the tub 120 to the predetermined water level. After that, the drum 130 is alternately rotated in the clockwise and counterclockwise directions such that a post washing process is carried out according to a predetermined program.

During the post washing process, the wash water heater 122 may be used to heat the wash water in the tub 120 to a predetermined temperature, or the circulating pump 160 may be operated by predetermined periods of time to circulate the wash water.

After the post washing process is completed, selected operations, such as a rinsing operation and a spin-drying operation, are successively carried out, and then the washing of the laundry is completed.

Meanwhile, when the washing of the laundry is completed in the state that the wash water is filled in the case 211 to the maximum water level, for example, in a cold weather, such as a winter season, the water supplied into the case 211 may be frozen.

The water, the volume of which is increased while the water is frozen, is filled in the spare space part 400, whereby the case 211 is prevented from bursting.

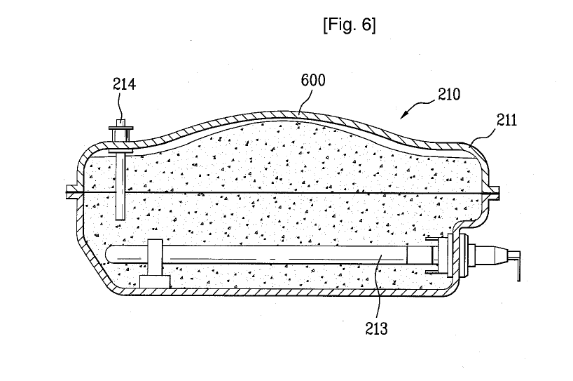

FIG. 5 is a perspective view illustrating the structure of a steam generator according to a second embodiment of the present invention, and FIG. 6 is a schematic view illustrating the internal structure of the steam generator according to the second embodiment of the present invention.

The second embodiment of the present invention is characterized in that the burst preventing unit is a convex part 600 which protrudes to secure the inner space of the case 211.

The second embodiment of the present invention is identical in construction to the first embodiment of the present invention except for the structure for preventing burst of the case. Consequently, a description of other structures will not be given.

As shown in FIG. 5, it is preferable that the convex part 600 be formed at the center region of the upper surface of the case 211.

Hereinafter, the freezing of the water supplied into the case 211 will be described.

The outside part of the water supplied into the case 211, which is in contact with the inner surface of the case 211, is frozen sooner, and the center part of the water supplied into the case 211 is frozen later. Air bubbles in the water supplied into the case 211 are collected to the center region of the upper surface of the water which is not in contact with the inner surface of the case 211, and the water is frozen while the center region of the water protrudes in the shape of a convex.

Consequently, it is preferable that the convex part 600 be formed at the center region of the upper surface of the case 211, whereby a space is secured at the center region of the upper surface of the case 211.

At this time, the convex part 600 is provided by forming the center region of the upper surface of the case 211 outwardly such that the inner space of the case 211 is expanded.

The steam generator according to the second embodiment of the present invention is operated as follows. When the washing of the laundry is completed in the state that the wash water is filled in the case 211 to the maximum water level at a low surrounding temperature, the water supplied into the case 211 is frozen, and therefore, the volume of the water is increased while the surface of the water protrudes in the shape of a convex.

At this time, even when the supplied water is frozen, and therefore, the volume of the water is increased as shown in FIG. 6, the water is filled in the convex part 600 provided at the upper surface of the case 211. Consequently, the case 211 is effectively prevented from bursting.

It will be apparent to those skilled in the art that various modifications and variations can be made in the present invention without departing from the spirit or scope of the invention. Thus, it is intended that the present invention Over the modifications and variations of this invention provided they come within the scope of the appended claims and their equivalents.

### INDUSTRIAL APPLICABILITY

The steam generator according to the present invention provides an effect of preventing the case from bursting due to the burst preventing unit provided at the upper surface of the case even when the water supplied into the case is frozen, and therefore, the volume of the water is increased. Consequently, the present invention has considerably high industrial applicability.

1. A steam generator for drum type washing machines, comprising:
a case constituting the external appearance of the steam generator; and
a burst preventing unit provided at the case for preventing the case from bursting when water supplied into the case is frozen.

2. The steam generator according to claim 1, wherein the burst preventing unit is a spare space part formed in the case.

3. The steam generator according to claim 2, wherein the spare space part is a space provided such that 10% more water, than when water is supplied to the maximum water level, can be supplied into the case.

4. The steam generator according to claim 2, wherein the spare space part is provided by forming one side part of the upper surface of the case outward to expand the inner space of the case.

5. The steam generator according to claim 2, wherein the spare space part is provided with an outlet port, through which steam is discharged.

6. The steam generator according to claim 1, wherein the burst preventing unit is a convex part which protrudes to secure the inner space of the case.

7. The steam generator according to claim 6, wherein the convex part is provided by forming the upper surface of the case outward to expand the inner space of the case.

8. A washing machine including a tub mounted in a cabinet, which Institutes the external appearance of the washing machine, for storing wash water, a drum rotatably mounted in the tub, and a steam generator mounted in the cabinet for supplying steam into the drum, wherein the steam generator comprises a burst preventing unit provided at a case, which Institutes the external appearance of the steam generator, for preventing the case from bursting when water supplied into the case is frozen.

9. The washing machine according to claim 8, wherein the burst preventing unit is a spare space part formed in the case.

10. The washing machine according to claim 9, wherein the spare space part is a space provided such that 10% more water, than when water is supplied to the maximum water level, can be supplied into the case.

11. The washing machine according to claim 9, wherein the spare space part is provided by forming one side part of the upper surface of the case outward to expand the inner space of the case.

12. The washing machine according to claim 9, wherein the spare space part is provided with an outlet port, through which steam is discharged.

13. The washing machine according to claim 8, wherein the burst preventing unit is a convex part which protrudes to secure the inner space of the case.

14. The washing machine according to claim 9, wherein the convex part is provided by forming the upper surface of the case outward to expand the inner space of the case.
